(19) United States
(12) Patent Application Publication
(10) Pub. No.: US 2020/0085029 A1
(43) Pub. Date: Mar. 19, 2020

(54) Drone-based insect sample-collection system and the method thereof

(71) Applicant: Jianheng CHEN, Dongguan (CN)

(72) Inventor: Jianheng CHEN, Dongguan (CN)

(21) Appl. No.: 16/147,778

(22) Filed: Sep. 30, 2018

(30) Foreign Application Priority Data
Sep. 13, 2018 (CN) 201811066712.8

(51) Int. Cl. A01M 1/02; B64C 39/02

(52) U.S. Cl. CPC A01M 1/026; B64C 2201/128; B64C 39/024

(57) ABSTRACT

A drone-based insect sample-collection system is disclosed, comprising a drone, a flight-control module and a sample-collection module. The flight-control module comprises a communication unit to transmit or receive signal to/from a user and a control unit to control the route of flight and collection site for the drone. The sample-collection module comprises a container, a gate-controlling unit, a chemicals-releasing unit and an optical-sensing unit. The container is provided with a gate which is controlled by the gate-controlling unit. The chemicals-releasing unit releases one or multiple chemicals to attract insects into the container. The optical-sensing unit is provided in the container and generates different signal according to the sensed light intensity. As the amount of the insect inside the container increases to gradually block the light intensity that the optical-sensing unit could sense, the signal generated by the optical-sensing unit is varied and transmitted to the gate-controlling unit.

### CROSS REFERENCE TO RELATED APPLICATIONS

This application is based upon and claims priority to Chinese Patent Application No. 201811066712.8, filed on Sep. 13, 2018, the entire contents of which are incorporated herein by reference.

### TECHNICAL FIELD

This invention is related to an unmanned flight system, particularly an unmanned flight system for insect sample collection.

### BACKGROUND

Many applications such as monitoring farm or forest by aerial photography, reporting news, scientific research or application in national security and law enforcement because an unmanned aerial vehicle can reach an area which is hard for human to reach. Besides, an unmanned aerial vehicle could be applied for epidemic prevention. Using an unmanned aerial vehicle to spray chemicals for epidemic prevention is quite cost-saving compared to using lots of vehicles, equipment and man power.

Although using unmanned aerial vehicles to spray chemicals for epidemic prevention may save man powers; however, an effective epidemic prevention relies on effective chemicals-spraying that is concentrated on epidemic area. Thus, an more effective epidemic-prevention action will be achieved if an biological sample collection and analysis corresponding to specific epidemic could be done to confirm the epidemic area that requires medicals-spraying.

As such, an unmanned aerial vehicle system for insect sample collection is disclosed in this patent. However, the application of this invention is not limited for epidemic prevention but is applicable for any other applications where insect sample-collection is needed.

### SUMMARY

A first objective of this invention is to propose an unmanned aerial vehicle for insect sample-collection, which comprises a drone, a flight-control module and a sample-collection module, which are carried by the drone. The flight-control module comprises a control unit and a communication unit. The control unit controls the drone in accordance with a pre-defined flight route or within a predefined aerial region, or it controls the flight route or sample-collection site according to a received signal. The communication unit is used to transmit a signal to a user or receive a signal from a user. The sample-collection module comprises a chemicals-releasing unit, a container, a gate-controlling unit and an optical-sensing unit. The chemicals-releasing unit may release one or multiple kinds of chemicals to attract insects into the container. The optical-sensing unit is provided within the container and generates different signals according to different sensed light intensity. The signal is transmitted to the gate-controlling unit. As the amount of the insects in the container reaches a certain level, the signal generated by the optical-sensing unit varies due to the light sensed by the optical-sensing unit is gradually blocked by the insect. While the signal exceeds over or is lower than a predefined value, the gate-controlling unit closes the gate to stop collecting the insects. This signal may be further transmitted to the control unit comprised by the flight-controlling module to control the drone to return or continue to next sample-collection site.

A second objective of this invention is to provide the abovementioned unmanned aerial vehicle for insect sample-collection, wherein the sample-collection module further comprises an optical source as a reference light source for the optical-sensing unit to sense the light intensity.

A third objective of this invention is to provide the abovementioned unmanned aerial vehicle for insect sample-collection, wherein the optical-sensing unit comprises a solar cell, which not only may generate different signal according to the sensed light intensity but also convert the sensed light to electric energy to supply the power required by this system.

A forth objective of this invention is to provide the abovementioned unmanned aerial vehicle for insect sample-collection, wherein the chemicals-releasing unit may receive the signal from the optical-sensing unit to adaptively modulate the unit quantity of the released chemicals.

A fifth objective of this invention is to provide the abovementioned unmanned aerial vehicle for insect sample-collection, wherein the signal generated by the optical-sensing unit is transmitted to the user.

A sixth objective of this invention is to provide the abovementioned unmanned aerial vehicle for insect sample-collection, which comprises an environmental parameter sensing unit to detect the environment parameters such as temperature, humidity, light intensity, light wavelength or the composition of the air where the drone locates. The information of the environmental parameters is transmitted to the control unit of the flight-control module such that the control unit determines the sample-collection site and the flight route of the drone, or the information of the environmental parameters is transmitted to the user via the communication unit of the flight-control module so that the user may further adjust or change the flight route and sample collection site according such information.

A seventh objective of this invention is to provide a method of an unmanned aerial vehicle for insect sample collection, which comprises the following steps: (a) after a drone reaches a sample collection site according to a predefined flight route, one or multiple kinds of chemicals is then released to attract insect into a container; (b) an optical-sensing unit which can generate different signal according to the sensed light intensity is provided within the container, and the signal generated by the optical-sensing unit is varied because the insects in the container blocks certain light that can be sensed by the optical-sensing unit; (c) while the signal exceeds over or is lower than a predefined value, the gate of the container is triggered to close and the insect sample collection stops then.

An eighth objective of this invention is to provide the abovementioned method of an unmanned aerial vehicle for insect sample collection, wherein the unit quantity of the released chemicals is further adaptively modulated according to the signal generated by the optical-sensing unit.

A ninth objective of this invention is to provide the abovementioned method of an unmanned aerial vehicle for insect sample collection, wherein the sample collection site of the drone is determined by information of environment parameters, which may be at least one of the follows: temperature, humidity, optical intensity, optical wavelength, and the composition of the air.

The specific technique of this invention is described in detail by the following embodiments and accompanying figures.

### BRIEF DESCRIPTION OF THE DRAWINGS

FIG. 1 is the system architecture diagram of the invention.

FIG. 2 is another system architecture diagram of the invention.

FIG. 3 is a flow chart of the method of collecting insect samples of this invention.

### DETAILED DESCRIPTION

To fully understand the objectives, features and functions, a detailed description is given by the specific embodiments and accompanying figures below.

Please refer to FIG. 1, the system architecture diagram of this invention. A flight control module 101 and a sample collection module 102 is carried on the unmanned aerial vehicle 100. The flight control module 101 comprises a communication unit 1011 and a control unit 1012, wherein the control unit 1012 is used to control the sample collection site or the flight route of the unmanned aerial vehicle 100, including the flight direction or control the unmanned aerial vehicle 100 to fly in a predefined region. The flight route or flight region can be pre-determined by externally programming the control unit 1012. The communication unit 1011 is used to receive and transmit a signal, such as a remote-control signal from the user, or other signals generated by the sensors or modules on the unmanned aerial vehicle 100. The sample collection module 102 comprises a container 1021, a gate-controlling unit 1022, a chemicals-releasing unit 1023 and an optical-sensing unit 1024. The chemicals-releasing unit 1023 releases one or multiple kinds of the compounds or mixtures of chemicals that is used to attract insects into the container 1021. The container 1021 is provided with a gate, of which the open and close is controlled by the gate-controlling unit 1022. While the signal generated by the optical-sensing unit 1024 exceeds over or is lower than a predefined value, the gate-controlling unit 1022 closes or open the gate to start or stop collecting the insect samples. The insects gathering in the container 1021 may blocks the light intensity sensed by the optical-sensing unit 1024 such that the signal generated by the optical-sensing unit 1024 corresponds to the collected quantity of the insect samples.

In another embodiment, the sample collection module 102 may further comprise a light source 1025, which is used as a reference light source of the light-sensing unit 1025. Therefore, while the optical-sensing unit 1024 senses less light intensity from light source 1024 due the increasing amount of the insects in the container 1021, the signal then changed as well to reach similar function in the previous embodiment. The wavelength of the light source 1025 may be specifically designed or selected to further attract specific kinds of insects such as mosquito, which can be referred by the reference.

The signal generated by the optical-sensing unit 1024 can be transmitted to the user via the communication unit 1011, allowing the user to inspect the status of insect collection. On the other hand, the user may further decide if the collection shall continue or stop according to the light-sensing unit 1024.

In one embodiment, the signal generated by the optical-sensing unit 1024 is transmitted to the chemicals-releasing unit 1023 so that the chemicals-releasing unit 1023 may modulate the unit quantity of the released chemicals by releasing speed. For example, while the signal generated by the optical-sensing unit 1024 corresponds to adequate quantity of insects, the chemicals-releasing unit 1023 may decrease the quantity of the released chemicals or the releasing speed.

In another embodiment, the optical-sensing unit 1024 may further comprises a solar cell, which not only generates different electro-optical current according to different sensed light intensity but also convert optical to electrical energy to supply the power required by this system.

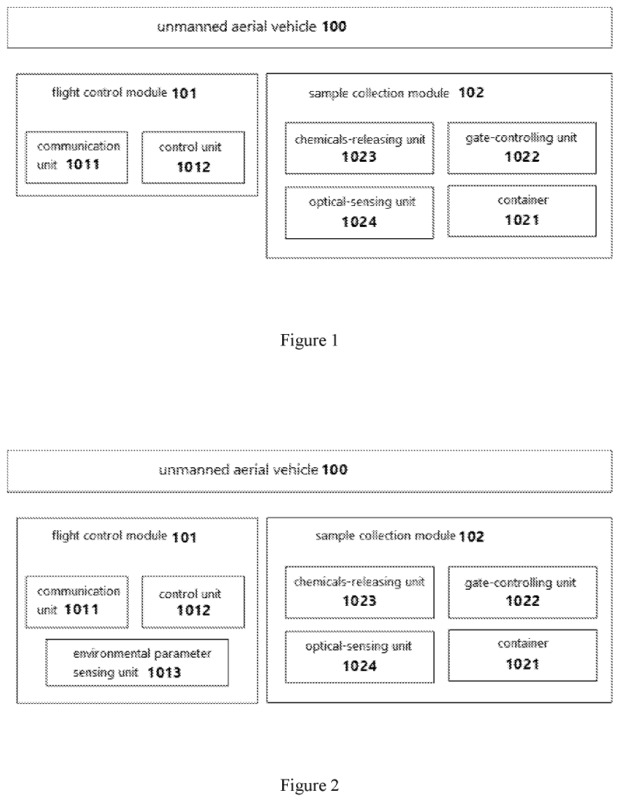

Referring to FIG. 2, which is another system architecture diagram of this invention. Compared to system architecture 10, the flight control module 101 of this system architecture may further comprises an environmental parameter sensing unit 1013, which is used to detect the environmental parameters where the unmanned aerial vehicle 100 locates and generate information of environment parameters such as humidity, temperature or composition of the air like pollen or dust, or light intensity, light wavelength etc. For example, if the target sample insect is mosquito, which may favor specific environmental humidity, then the humidity information transmitted to the control unit 1012 could be used to determine the flight route or sample collection site of unmanned aerial vehicle 100. For example, a specific range of humidity appropriate for insect sample collection can be set in advance; while the information of the environmental humidity generated by the environmental parameters sensing unit 1013 fits in the range of humidity, the control unit 1012 controls the unmanned aerial vehicle 100 to proceed sample collection at this location. On the other hand, if the information of the environmental humidity generated by the environmental parameters sensing unit 1013 does not fall into the range of humidity, the control unit 1012 control the unmanned aerial vehicle 100 to continuing its journey to next location.

In other embodiment, the information of environmental parameters generated by the environmental parameters sensing unit 1013 may be transmitted to the user via the communication unit 1011. The user may further control flight route or sample collection site of the unmanned aerial vehicle 100 by referring the information.

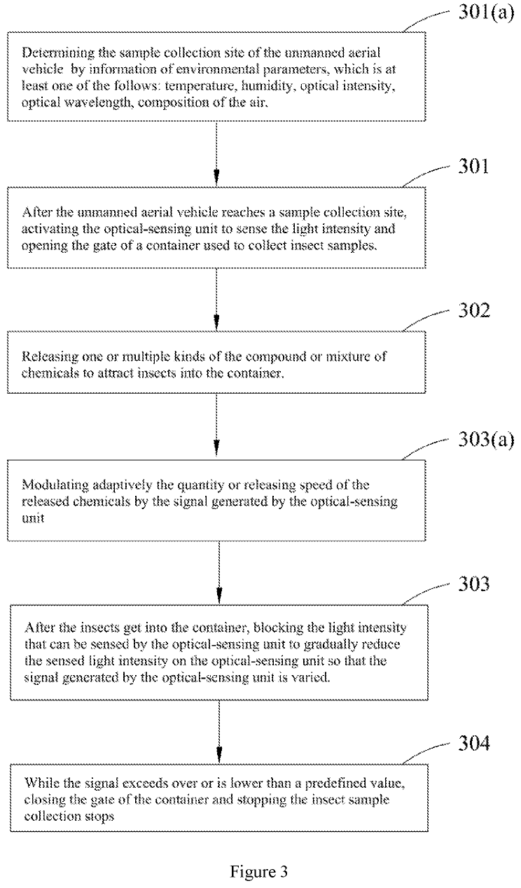

A method of collecting insect samples is provided in this invention as well. Referring to FIG. 3, a flow chart of the method of collecting insect samples of this invention is shown. The method comprises step 301: the unmanned aerial vehicle reaches a sample collection site, activate the optical-sensing unit to sense the light intensity and open the gate of a container used to collect insect samples; step 302: one or multiple kinds of the compound or mixture of chemicals is released to attract insects into the container; and step 303: after the insects get into the container, it will block the light intensity that can be sensed by the optical-sensing unit to gradually reduce the sensed light intensity on the optical-sensing unit so that the signal generated by the optical-sensing unit is varied; step 304: while the signal exceeds over or is lower than a predefined value, the gate of the container closes and insect sample collection stops.

In yet another embodiment, an extra step 303(a) is comprised in step 303: the quantity or releasing speed of the released chemicals is adaptively modulated by the signal generated by the optical-sensing unit.

In another embodiment, there is one more step 301(a) prior to step 301: the sample collection site of the unmanned aerial vehicle is determined by information of environmental parameters, which is at least one of the follows: temperature, humidity, optical intensity, optical wavelength, composition of the air.

Although the embodiments of the present invention are disclosed as above, these embodiments shall not be considered to restrict the present invention. Those modification that Person having ordinary skill in the art may make to the shape, structure, feature, method and/or quantity according to the claims of the present invention shall be covered by the scope of the present invention and the protected scope of the present invention shall be considered by the claims attached to this specification.

We claim:

1. A drone-based insect sample-collection system, comprising:
a drone;
a flight-control unit comprising a communication unit and a control unit, wherein the communication unit is configured to receive or transmit a signal and the control unit is configured to control flight route or sample collection site of the drone;
a sample-collection module comprising a container, a gate-controlling unit, a chemicals-releasing unit and an optical-sensing unit, wherein the container is provided with a gate which is controlled by the gate-controlling unit, the chemicals-releasing unit releases at least one kind of chemicals and the optical-sensing unit generates the signal corresponding to an amount of insects in the container, and the signal is transmitted to the gate-controlling unit;
while the signal exceeds over or is lower than a predefined value, the gate-controlling unit opens or closes the gate.

2. The drone-based insect sample-collection system of claim 1, wherein the signal is further transmitted to the chemicals-releasing unit so that the chemicals-releasing unit adaptively modulate the unit quantity of the released chemicals.

3. The drone-based insect sample-collection system of claim 1, further comprising an optical source configured for the optical-sensing unit to generate the signal corresponding to the amount of the insect in the container.

4. The drone-based insect sample-collection system of claim 1, wherein the signal corresponding to the amount of the insect in the container generated by the optical-sensing unit is transmitted to the communication unit and is transmitted to a user via the communication unit.

5. The drone-based insect sample-collection system of claim 1, wherein the optical-sensing unit comprises a solar cell to generate the signal corresponding to the amount of the insects in the container and convert light to electric energy.

6. The drone-based insect sample-collection system of claim 1, further comprising an environment parameter sensing unit configured to sense at least one of environment parameters selected from the group consisting of temperature, humidity, light intensity, light wavelength and the composition of the air, and generate information of the environmental parameters.

7. The drone-based insect sample-collection system of claim 6, wherein the information of environmental parameters is transmitted to the control unit, and the control unit determines the flight route or the sample collection site of the drone.

8. The drone-based insect sample-collection system of claim 6, wherein the information of environmental parameters is transmitted to a user via the communication unit.

9. A method of drone-based insect sample-collection, comprising:
(a) landing a drone on a sample collection site, opening a gate of a container configured to collect insect samples and switching on an optical sensing unite to sense light intensity for generation of a signal;
(b) releasing chemicals to attract the insect samples into the container;
(c) varying the signal generated by the optical sensing unit with the light intensity, and where the light intensity is blocked by an amount of the insect samples in the container;
(d) and wherein while the signal exceeds over or is lower than a predefined value, the gate of the container closes and stops sample collection.

10. The method of drone-based insect sample-collection of claim 9, wherein a unit quantity of the released chemicals is modulated adaptively with the signal generated by the optical sensing unit.

11. The method of drone-based insect sample-collection of claim 9, wherein the sample collection site is determined by one or multiple environmental parameters selected from the group consisting of temperature, humidity, optical intensity, optical wavelength and composition of air.

12. The drone-based insect sample-collection system of claim 3, wherein the signal corresponding to the amount of the insects in the container generated by the optical-sensing unit is transmitted to the communication unit and is transmitted to a user via the communication unit.
